(19) United States
(12) Patent Application Publication
(10) Pub. No.: US 2006/0286917 A1
(43) Pub. Date: Dec. 21, 2006

(54) VARIABLE EXHAUST CONTROL FOR SPRAY BOOTHS

(75) Inventor: Jean-Pierre Dionne, Montréal, QC (CA)

Correspondence Address: BERESKIN AND PARR, 40 KING STREET WEST, BOX 401, TORONTO, ON, M5H 3Y2, CA

(73) Assignee: NOVEO TECHNOLOGIES INC., Anjou (CA)

(21) Appl. No.: 11/424,065

(22) Filed: Jun. 14, 2006

Related U.S. Application Data
(60) Provisional application No. 60/690,511, filed on Jun. 15, 2005.

(51) Int. Cl. B05B 15/12; B05B 15/04

(52) U.S. Cl. 454/53; 454/50; 118/326; 118/309; 118/663

(57) ABSTRACT

An exhaust control system for a spray booth having at least one fan motor. The exhaust control system comprises a spraying activity detector and a speed control circuit for an electrical motor. The speed control circuit is connected to the fan motor and is linked to the detector so as to adjust the speed of the motor in a variable manner as a function of at least the spraying activity. A method for controlling an exhaust system of a spray booth having at least one fan motor comprising the steps of detecting a spraying activity and, upon detection of the spraying activity, increasing an air volume exhaust rate of the exhaust system.

### FIELD OF THE INVENTION

The present invention relates to the field of spray booths exhausts systems. More specifically, the present invention relates to an energy saving exhaust system for a spray booth.

### BACKGROUND OF THE INVENTION

Spray booths require an air circulation in order to maintain a safe workplace for persons working in these booths. The amount of air circulated through a workplace varies as a function of the flow rate required in the design. In most cases, the latter is based on the speed of 100 feet per minute required for the transport of particles when spraying. However, there are not continuous spraying activities inside the spray booth. Indeed, there are many periods of time during which no spraying occurs: personal breaks of painters, time to prepare the equipment. All those periods of time only require a level of air exhaust permitting dilution ventilation. Such ventilation level is many times less than the one required for particles transportation. Maintaining a constant exhaust flow rate during these periods provides a significant waste of energy.

Canadian patent 1,134,129 describes a spray booth exhaust system control. The use of the spray gun is detected by assuming that when the gun is not on its stand or hooked on the wall, it must be used. Therefore, when the detection is made, a damper or register is activated such as to reduce the exhaust air flow rate. The problem with this system is that, sometimes, the spray gun is neither on its stand and nor being used. For example, it may well be in the hands of the painter, but he is not actually painting with it, or the painter may have left the spray booth without having put back the spray gun on its stand. This system still wastes energy during such time.

There is therefore a need for an improved energy saving exhaust system for a spray booth.

### SUMMARY OF THE INVENTION

A chamber, a hall, a booth, or an area (1) used to confine the particles emitted by at least a spraying device (2) is generally provided with a filtering member (3), which permits to reduce or eliminate evacuated particles in an exhaust duct (4) by means of an exhaust fan (5). The exhaust fan is operated by a motor (6), which is coupled to a variable speed controller (7). The rotation speed of the fan is controlled by a control circuit (8) installed in a control cabinet (9) or is a member of the variable speed controller (7). The exhaust level during the spraying is maintained at an adequate exhaust level to assure particle transportation (10). When a spraying device is turned off, the exhaust flow rate is reduced to a minimum by reducing the speed of the exhaust fan (5). A detection device (11), (18) or (19) is generally mounted on the spraying device (2) or on the compressed air inlet for the spraying device (12), detects use of the spraying device (12) so as to indicate to the controller the necessity of increasing the exhaust at its normal activity threshold.

Variation of the speed of the motor can be directly a function of the detection of the spraying, or according to an exhaust model considering at least the dimensions of the booth, the exhaust speed and estimated quantity of aerosol matter or sprayed matter which is present in the air, as well as the acceptable quantity threshold.

It is therefore an object of the present invention to provide an exhaust control system for a spray booth which overcomes the above drawbacks.

It is another object of the present invention to provide an exhaust control system for a spray booth which saves energy.

It is another object of the present invention to provide an exhaust control system for a spray booth which adjusts the exhaust as a function of a spraying activity.

According to one aspect of the invention, there is provided an exhaust control system for a spray booth having at least one fan motor. The exhaust control system comprises a spraying activity detector and a speed control circuit for an electrical motor. The speed control circuit is connected to the fan motor and is linked to the detector so as to adjust the speed of the fan motor in a variable manner as a function of at least the spraying activity.

Preferably, the spraying activity detector comprises a flow meter in a compressed air feed of at least one spray gun. The flow meter may be connected to, at its outlet, a plurality of spray guns. Advantageously, the exhaust control system comprises a cabinet having a compressed air inlet, a compressed air outlet, an electrical power supply input for the motor, and an electrical power supply output for the motor. The cabinet contains the control circuit and the flow meter. Preferably, the cabinet is further equipped with a speed control signal output. The cabinet contains a logic unit of the control circuit and the flow meter. The control circuit comprises a speed variator unit coupled to the motor receiving the speed control signal from the cabinet.

Alternatively, the spraying activity detector of the exhaust control system comprises an opacity probe. The opacity probe is preferably located within the spray booth in a location adequate to detect byproducts of spraying activity. It is also possible for the spraying activity detector comprises to use an electrical contact activated by a trigger installed on a spray gun. Another way of achieving the same result may also be accomplished by the spraying activity detector being equipped with a motion detector in the spray booth to detect the presence of an operator.

In any of these options, the speed of the motor is adjusted as a function of the actual spraying activity. It is further possible to adjust the speed of the motor as a function of the actual spraying activity and time.

According to another aspect of the invention, there is provided a method for controlling an exhaust system of the spray booth. The method comprises the steps of detecting the spraying activity and, upon detection of the spraying activity, increasing an air volume exhaust rate of the exhaust system. Preferably, the method further comprises a step of increasing an air volume rate of a make-up air supply. More preferably, the air volume exhaust rate is increased to maximum values according to established standards.

The method is also provided with steps to detect the end of the spraying activity and, upon detection of the end of the spraying activity, reduce the air volume exhaust rate. Preferably, the air volume exhaust rate is reduced after a period of time following the detection of the end of the spraying activity. More preferably, both the air volume exhaust rate and the air volume rate of the make-up air supply are reduced to minimal values.

Optionally, the method further comprises the steps of detecting a failure of detecting the spraying activity and, upon detection of the failure to detect the spraying activity, increasing the air volume exhaust rate and the air volume of the make-up air supply to maximum values according to established standards.

Applicants have found that by using this exhaust control system and this methodology, energy savings are materialized.

### BRIEF DESCRIPTION OF DRAWINGS

In the following description, which represents a preferred embodiment of the invention, reference is made to the drawings included in the present application wherein:

FIG. 1 is a perspective view of a spray booth provided with an exhaust system according to a preferred embodiment; and

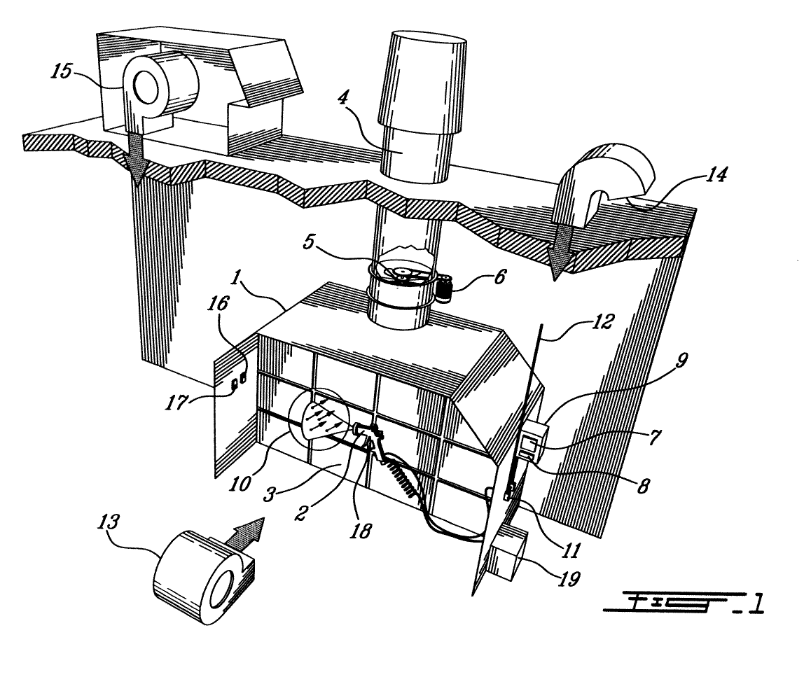

FIG. 2 is an electro-pneumatic diagram of an exhaust system according to the preferred embodiment.

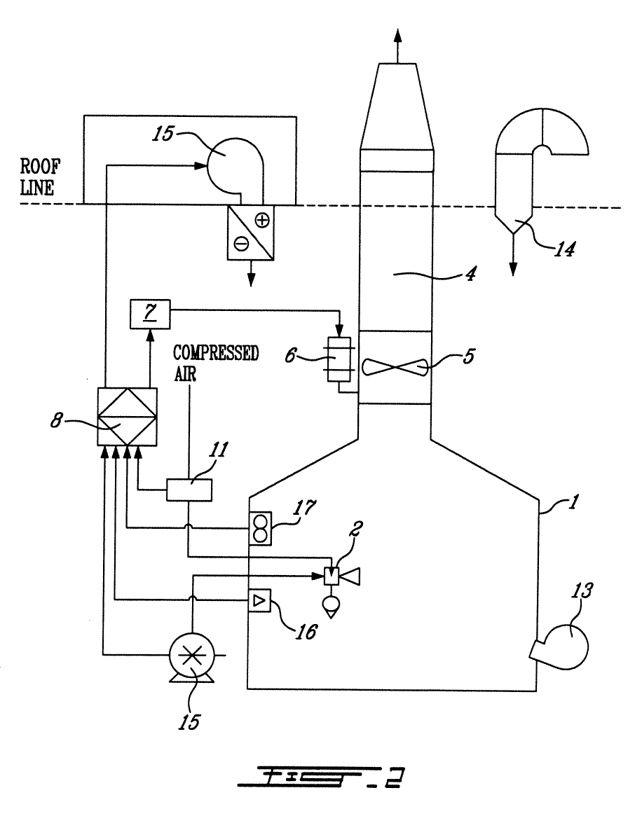

### DETAILED DESCRIPTION OF THE INVENTION

A spraying process can include, without being limited to, the application of paint, lacquer, or primer sealer, or the treatment of a surface. Such a spraying process produces contaminants, solvents, dust or particles in suspension, which are by-product of the spraying.

The present invention may be used in a process producing dust which has to be evacuated, or in a process where the air acting as a carrier of dust is exhausted or re-circulated in a building, an enclosure or a cabinet.

The definition of process equipment operation includes one or more spraying processes and one or more processes producing dust.

In the case of spraying processes and processes producing dust particles, the contaminants or dust particles must be evacuated in the work area by an air movement across the work area. The air movement is usually produced by an exhaust fan (5). In certain cases, a fan (13) pushes contaminants towards the exhaust enclosure (“push-pull” process).

The enclosure (1) is a chamber, a hall, a cabinet, or an enclosure which is used to confine and direct solvents, dust particles and other contaminants produced as a by-product of the spraying process and of the process producing dust particles (10).

A filtration system (3) is generally installed in order to capture dust particles (10) or particles before exhausting the air towards the exterior by means of an exhaust conduit (4) or by re-circulating the process air where this is permitted or possible.

Exhausting or re-circulating air systems require energy in relation with the propelling force of the fans (5) and (13).

In a building, air that is evacuated must be replaced by a natural means such as an air intake (14) or by mechanical means such as an air make-up (or fresh air inflow) (15). Such a replacement air must be conditioned both to keep adequate processes temperatures and to provide comfort to the occupants. Such conditioning of the air can be heating, humidifying, dehumidifying, cooling or filtering. All of these processes for conditioning air use energy.

The objective of decreasing the exhausting of air is to both reduce the energy used by the propelling force (6), (13) and (15) required to transport or displace air and to reduce the requirements in fresh air replacement which has to be treated.

An objective of controlling the variation of the exhaust flow rate of the spray exhaust processes and of the dust producing processes is to save energy.

Control of the flow rate variation is initiated by the detection of the use of spraying devices or of any other device producing contaminants that must be evacuated. The control device (8) consists of an electronic circuit, which receives an input signal corresponding to the detection of the use of the process equipment, interpreting the signal as a requirement to exhaust at high speed, and providing an output signal allowing varying the speed of the exhaust fan, the re-circulation fan and/or the make-up air fan.

The detection signal of the use of the process equipment preferably initiates from detecting a compressed air flow used in the process by installing a measuring device on the compressed air inlet (12).

In the case of the prototype, the detection of operation of the process equipment was accomplished by using an in-line variable area flowmeter (11) Omega model FLR-6720-I, provided with a 4-20 milliamps signal transmitter. This flow meter (11) is installed on the compressed air line (12) supplying the spraying device (2).

The second recommended method of detection of process equipment operation can be accomplished with the use of an in-line variable area flow meter provided with a switch that is adjustable at a given flow rate. This flow meter (11) shall be installed on the compressed air line (12) supplying the spraying device (2).

The third recommended method of detection of process equipment operation can be accomplished with the use of a turbine flow meter provided with an adjustable flow rate setpoint or with a signal transmitter. This flow meter (11) shall be installed on the compressed air line (12) supplying the spraying device.

In the three cases mentioned above, the flow meter (11) can be installed at any location on the compressed air line (12) feeding the spraying device (2). A cable transmits the signal to a control cabinet (7), which contains the command circuit (8).

The signal detecting the operation of the process equipment can also be initiated by:
An electrical contact activated by the process equipment trigger (18).
The detection of pump operation or operation of an apparatus serving the process by a pump operation detector (19).
Detecting the presence of an operator in the work area.
A motion detector (16) located in the work area.
A beam or a probe permitting to detect the presence of contaminants. Such a probe may be, for example, an infrared opacity probe (17). In this case, the probe is installed in a position adequate to detect dust particles (10), contaminants or any spraying activity byproducts flowing in the direction of the filtration system (3).

The control circuit can either be separated from the detection system or be part of it.

Interpretation of the detection signal and the recommended action are programmed in the command circuit (8). Recommended actions as function of the input signals are described in the operation sequences.

In the case of the prototype, the speed variation of the exhaust fan (5), the fan (13) and the air make-up (15) is controlled by means of a Toshiba Series S-11 variable speed device. These speed controllers receive a 0-10 VDC signal from the command circuit (8).

The command circuit (8) can be separated from the variable speed controller or can be an integral part of it.

The command circuit (8) can be an integral part of the detection and variable speed controller systems.

The operation sequences comprise, but are not limited to, the following elements:
In a period where process equipment is not in operation, exhaust and make-up air supply are at their minimal values.
Upon detection of operation of the process equipment, the exhaust and make-up air supply are increased to maximum values according to established standards.
Upon detection of the end of operation of the process equipment, a timer allows the air volume exhaust rate to continue at high speed for a given period of time and thereafter reducing the speed.
Upon detection of failure of a detection component, or of a lack of information regarding the status, the system acts such as that the exhaust and the make-up airflows are increased to maximum values according to established standards.

1. An exhaust control system for a spray booth having at least one fan motor, said exhaust control system comprising:
a spraying activity detector; and
a speed control circuit for an electrical motor, said speed control circuit being connected to said fan motor and being linked to said detector so as to adjust a speed of said fan motor in a variable manner as a function of at least said spraying activity.

2. A control system according to claim 1 wherein said spraying activity detector comprises a flow meter in a compressed air feed of at least one spray gun of said spray booth.

3. A control system according to claim 2, wherein said flow meter is connected to, at its outlet, a plurality of spray guns.

4. A control system according to claim 3 further comprising a cabinet having a compressed air inlet, a compressed air outlet, an electrical power supply input for said motor, and an electrical power supply output for said motor, said cabinet containing said control circuit and said flow meter.

5. A control system according to claim 3 further comprising a cabinet having a compressed air inlet, a compressed air outlet, and a speed control signal output, said cabinet containing a logic unit of said control circuit and said flow meter, and said control circuit comprising a speed variator unit coupled to said motor receiving the speed control signal from said cabinet.

6. A control system according to claim 1 wherein said spraying activity detector comprises an opacity probe.

7. A control system according to claim 6 wherein said opacity probe is located within the spray booth in a location adequate to detect byproducts of said spraying activity.

8. A control system according to claim 1 wherein said spraying activity detector comprises an electrical contact activated by a trigger installed on a spray gun.

9. A control system according to claim 1 wherein said spraying activity detector comprises a motion detector in the spray booth to detect the presence of an operator.

10. A control system according to claim 1 wherein the speed of said motor is adjusted as a function of the actual spraying activity.

11. A control system according to claim 1 wherein the speed of said motor is adjusted as a function of the actual spraying activity and time.

12. A method for controlling an exhaust system of a spray booth having at least one fan motor, said method comprising the steps of:
detecting a spraying activity; and
upon detection of said spraying activity, increasing an air volume exhaust rate of the exhaust system.

13. A method according to claim 12 further comprising a step of increasing an air volume rate of a make-up air supply.

14. A method according to claim 13 wherein said air volume exhaust rate is increased to maximum values according to established standards.

15. A method according to claim 14 further comprising the steps of:
detecting an end of said spraying activity; and
upon detection of said end of said spraying activity, reducing said air volume exhaust rate.

16. A method according to claim 15 wherein said air volume exhaust rate is reduced after a period of time following said detection of said end of said spraying activity.

17. A method according to claim 16 wherein said air volume exhaust rate and said air volume rate of said make-up air supply are reduced to minimal values.

18. A method according to claim 14 further comprising the steps of:
detecting a failure of detecting said spraying activity; and
upon detection of said failure to detect said spraying activity, increasing said air volume exhaust rate and said air volume of said make-up air supply to maximum values according to established standards.
